(19) United States
(12) Patent Application Publication
(10) Pub. No.: US 2012/0215681 A1
(43) Pub. Date: Aug. 23, 2012

(54) SYSTEM AND METHOD FOR PROVIDING PRE-QUALIFIED AND GUARANTEED FINANCIAL PRODUCTS

(75) Inventors: Lawrence Kevin JENKINS, Richmond, VA (US); Ellen Andrea Falbo, Arlington, VA (US); Marc G. Nystrom, Richmond, VA (US)

(73) Assignee: Capital One Financial Corporation, McLean, VA (US)

(21) Appl. No.: 13/207,066

(22) Filed: Aug. 10, 2011

Related U.S. Application Data
(60) Provisional application No. 61/444,515, filed on Feb. 18, 2011.

(51) Int. Cl. G06Q 40/00

(52) U.S. Cl. 705/38

(57) ABSTRACT

Techniques for providing pre-qualified and guaranteed financial products are disclosed. In one exemplary embodiment, the techniques may be realized as a computer-implemented method for providing a guaranteed financial product to a customer. The computer-implemented method may include receiving, from a communications device, customer information associated with a user. The computer-implemented method may also include determining, using a financial institution communications device, a credit score and an assessment of the credit-worthiness of the user based on the customer information. The computer-implemented method may further include outputting, to the communications device, the credit score and the assessment of the credit-worthiness of the user. The computer-implemented method may still further include determining, using the financial institution communications device, whether the user is eligible for guaranteed approval for one or more financial products based on the credit score and the assessment of the credit-worthiness of the user.

### CROSS-REFERENCE TO RELATED APPLICATIONS

This application claims priority to U.S. Provisional Patent Application No. 61/444,515, filed Feb. 18, 2011, which is hereby incorporated by reference in its entirety.

### FIELD OF THE DISCLOSURE

The present invention relates to a system and method for providing pre-qualified and guaranteed financial products.

### BACKGROUND OF THE DISCLOSURE

Financial institutions may pre-qualify or pre-approve customers for various financial products, such as credit cards. A customer is typically pre-qualified or pre-approved for a financial product based on information that a financial institution may obtain about the customer. For example, the pre-qualification and pre-approval determinations may be based on a customer's credit score, annual income, and other information provided by the customer during an application process. Unfortunately, there is very little transparency in the pre-approval and pre-qualification process. As a result, many customers are often unaware of the basis for the determination of whether a financial product is offered or not. This lack of transparency leads to frustration on the part of the customer. These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for pre-qualifying and guaranteeing a customer for a financial product according to an exemplary embodiment.

FIG. 2 depicts a customer information interface according to an exemplary embodiment.

FIG. 3 depicts a credit score interface according to an exemplary embodiment.

FIG. 4 depicts a flowchart for a method of pre-qualifying and guaranteeing a customer for a financial product according to an exemplary embodiment.

FIG. 5 depicts another flowchart for a method of pre-qualifying and guaranteeing a customer for a financial product according to an exemplary embodiment.

### DETAILED DESCRIPTION OF THE EMBODIMENTS

The following description is intended to convey a thorough understanding of the embodiments described by providing a number of specific exemplary embodiments and details involving systems and methods for providing pre-qualified and guaranteed financial products. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

According to the various embodiments of the present disclosure, a financial institution may pre-qualify and/or guarantee a customer for a particular financial product. The customer may also be provided with a credit score and an assessment of the credit-worthiness of the customer to serve as a rationale for the basis for offering or not offering the customer guaranteed approval financial products or financial products with one or more guaranteed terms. Furthermore, the customer may be provided with recommendations on improving their credit score. It is beneficial for the customer to receive a credit score before receiving an indication of which financial products she is approved or denied in order to improve transparency and customer confidence during the application process for financial products. The credit score may provide objective context to the consumer about why they may be approved for specific terms, lines, or products as it is provided by a third party.

It should be understood that the term “financial product” may relate to any number of products that may be offered by a financial institution. By way of non-limiting examples, “financial product” may refer to a line of credit, a credit card, a home equity loan, an auto loan, a personal loan, or any other financial product where a financial institution may investigate the creditworthiness of an individual or business entity before offering the financial product on given terms, if at all.

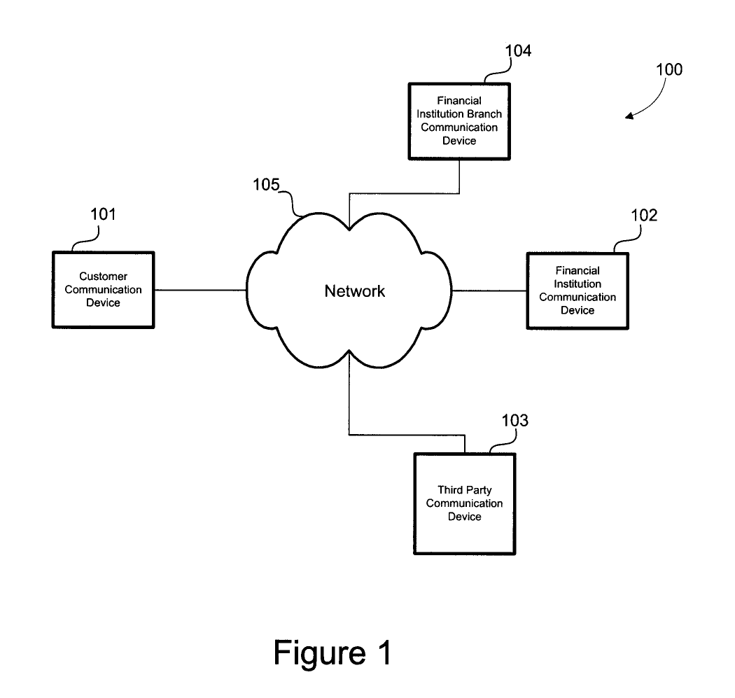

FIG. 1 is a schematic diagram illustrating a system 100 for providing pre-qualified or guaranteed financial products, in accordance with an exemplary embodiment. As illustrated, system 100 may include one or more networks, such as network 105. Network 105 may be one or more of a wireless network, a wired network or any combination of wireless network and wired network. For example, network 105 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 105 may include, without limitation, telephone lines, fiber optics, IEEE Ethernet 902.3, a wide area network (“WAN”), a local area network (“LAN”), or a global network such as the Internet. Also network 105 may support an Internet network, a wireless communication network, a cellular network, or the like, or any combination thereof. Network 105 may further include one network, or any number of the exemplary types of networks mentioned above, operating as a stand-alone network or in cooperation with each other. Network 105 may utilize one or more protocols of one or more network elements to which they are communicatively coupled. Network 105 may translate to or from other protocols to one or more protocols of network devices. Although network 105 is depicted as a single network, it should be appreciated that according to one or more embodiments, network 105 may comprise a plurality of interconnected networks, such as, for example, the Internet, a service provider's network, a cable television network, corporate networks, and home networks.

Customers may access network 105 through one or more customer communication devices 101 that may be communicatively coupled to network 105. A financial institution may access network 105 through one or more financial institution communication devices 102 that may be communicatively coupled to network 105. A financial institution branch 104 may access network 105 through one or more financial institution branch communication devices 104 that may be communicatively coupled to network 105. Third party customer information providers may access network 105 through one or more third party communication devices 103 that may be communicatively coupled to network 105. Communication devices 101, 102, 103, and 104 may include, for example, wireless phones, Personal Digital Assistants (PDA), desktop computers, laptop computers, servers, other computers or any combination thereof.

Customer communication devices 101, financial institution communication devices 102, financial institution branch communication devices 104, and third party communication devices 103 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiple Access (CDMA) based systems suitable for transmitting and receiving data. Data may be transmitted and received wirelessly or may utilize cabled network connection or telecom connections, fiber connections, traditional phone wireline connection, a cable connection or other wired network connection.

The customer communication device 101 may be configured to allow a customer to input customer information. In one embodiment, customer information may include any, or a combination, of customer employment status, customer references, customer personal information, customer address, customer date of birth, customer social security number, customer authorization to retrieve customer information from credit bureaus, whether customer is a home owner or a renter, customer monthly housing payments, and any other information that a financial institution may request in order to pre-qualify or approve a customer for a financial product. In another embodiment, the customer information may be accessed at a third party communication device 103 or financial institution database (e.g., associated with a financial institution branch communication device 104, associated with a financial institution communication device 102).

The customer communication device 101 may allow a customer to input customer information using one or more application types, which may be accessed, for example, via banner ads, websites, tablet devices, computers, or automated teller-machines.

In one embodiment, an application type may be selected by the customer. In another embodiment, an application type may be selected by a financial institution. In yet another embodiment, an application type may be selected based on any, or a combination, of user geographical location, demographic information, and random sampling.

The financial institution communication device 102 may receive and process the customer information to determine a credit score associated with the customer and an assessment of the customer's credit-worthiness based on the customer information. In one embodiment, the financial institution communication device 102 may access a customer's credit score by communicating with one or more third-party systems (e.g., third party communication device 103). For example, the financial institution communication device 102 may communicate with a first third-party system associated with a credit reporting agency (e.g., Equifax) to access a customer's credit score. In another example, the financial institution communication device 102 may communicate with a second third-party system associated with another credit reporting agency (e.g., Transunion) to access a customer's credit score. In yet another example, the financial institution communication device 102 may communicate with a third third-party system associated with another credit reporting agency (e.g., Experian) to access a customer's credit score.

The financial institution communication device 102 may determine an assessment of a customer's credit-worthiness by analyzing corresponding customer information and one or more corresponding credit scores. The financial institution communication device 102 may output any, or a combination, of one or more credit scores, an assessment of a customer's credit-worthiness, and one or more ways a customer may improve their credit scores or assessment prior to determining if the customer is eligible for guaranteed approval of one or more financial products or one or more guaranteed terms associated with a financial product.

It should be appreciated the foregoing discussion related to FIG. 1 is illustrative only, and that the various embodiments of the invention may be implemented by any other appropriate system or method.

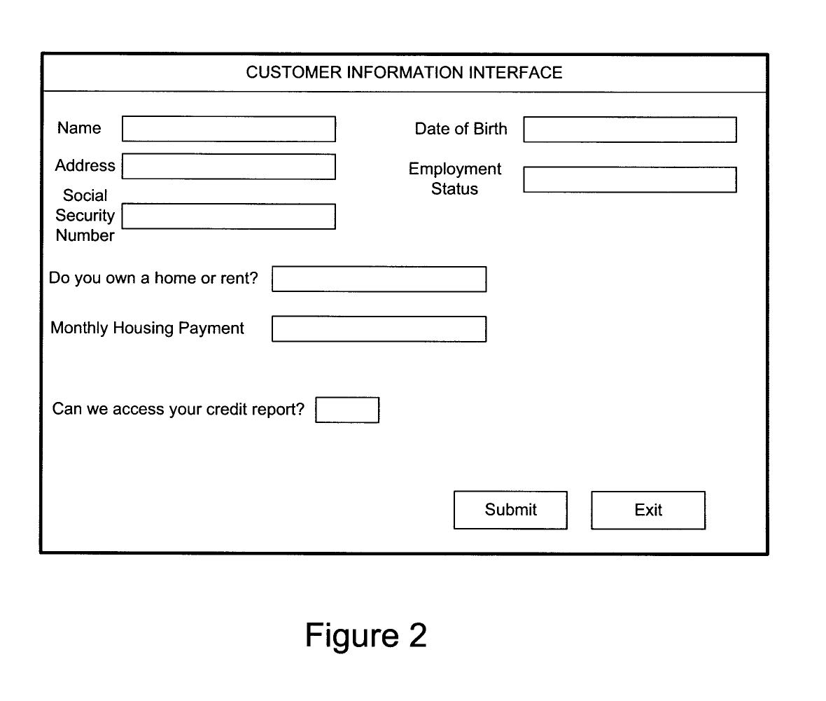

FIG. 2 depicts a customer information interface according to an exemplary embodiment. As illustrated in FIG. 2, a customer may input customer information into a customer interface using an input device (e.g., keyboard, mouse, scanner, etc.) associated with a customer communication device 101. For example, the customer may input any, or a combination, of a name using a name field, an address using an address field, a social security number using a social security number field, a date of birth using a date of birth field, an employment status using an employment status field, a home/rent status using a home/rent field, a monthly housing payment using monthly housing payment field, a credit report access authorization using a credit report access authorization field, and any other information that a financial institution may request in order to pre-qualify or approve a customer for a financial product as customer information. After customer information is inputted, a customer may submit the customer information to the financial institution communication device 102 by activating (e.g., clicking on) the “Submit” button. The customer may also exit the customer information interface by activating (e.g., clicking on) the “Exit” button.

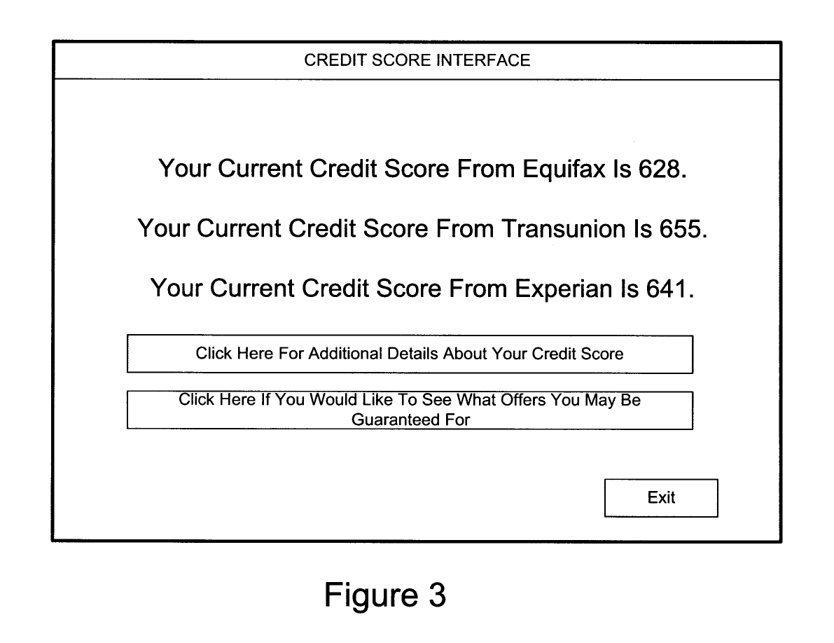

FIG. 3 depicts a credit score interface according to an exemplary embodiment. As illustrated in FIG. 3, a credit score interface may be displayed to a customer after receipt of customer information. A credit score interface may display one or more credit scores accessed using the customer information received. In one embodiment, a customer may view one or more ways to improve a credit score by activating (e.g., clicking on) the “Click Here For Additional Details About Your Credit Score” button. In another embodiment, a customer may view one or more guaranteed approval offers by activating (e.g., clicking on) the “Click Here If You Would Like To See What Offers You May Be Guaranteed For” button. The customer may also exit the credit score interface by activating (e.g., clicking on) the “Exit” button. It should also be appreciated that ways for the customer to improve her credit score or offers that the customer may be guaranteed approval for may be presented directly to the customer, without the need to click an additional activation button.

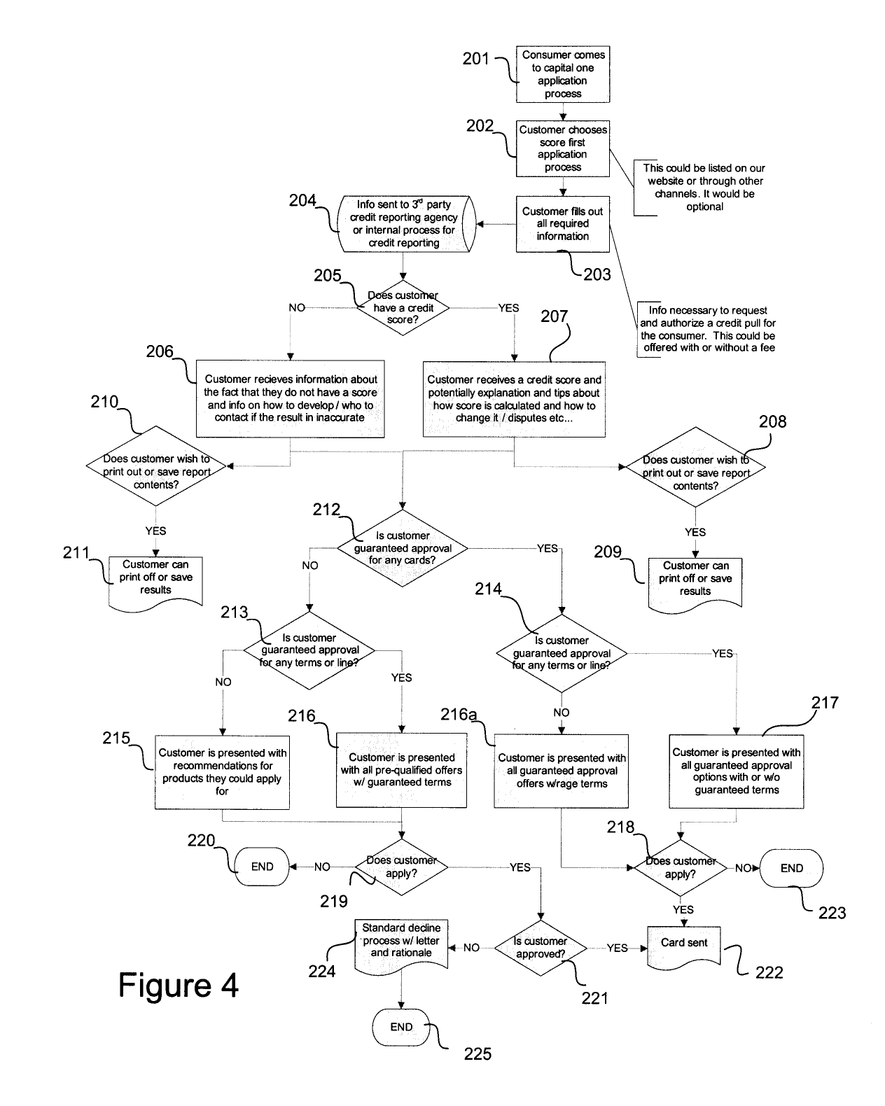

FIG. 4 depicts a flowchart for a method of providing pre-qualified and guaranteed financial products. In box 201a customer interacts with a financial institution to begin the application process. This process may begin by accessing a data entry from a financial institution, including an electronic form residing on a financial institution network server, an electronic form residing on a computer, an electronic form accessible via email, and an electronic form accessible via mobile phone, a Personal Digital Assistant (PDA), a laptop computer or any other electronic device. As shown in box 202, a customer may then chose a specific application type to continue the application process. In a further exemplary embodiment, the application is provided without any input from the customer. In this exemplary embodiment, a financial institution chose an application type for the customer based upon any number of criteria, including customer location, demographic information, or random sampling.

In box 203 the customer fills out the information requested on the application form. The requested information may include, for example, customer employment status, customer references, customer personal information, customer address, customer date of birth, customer social security number, customer authorization to retrieve customer information from credit bureaus, whether customer is a home owner or a renter, customer monthly housing payments and any other information that a financial institution may request in order to pre-qualify or approve a customer for a financial product.

In box 204, the information provided by the customer may be transmitted to a third-party credit reporting agency or an internal process for credit reporting. The third-party credit reporting agency or internal process for credit reporting may then determine whether the customer has a credit score, as depicted at step 205. As shown in box 206, if the customer does not have a credit score, the customer may receive an indication of the same, along with financial institution contact information in the event that the customer wishes to dispute the accuracy of the credit score determination. As shown in boxes 210 and 211, the customer may print off or save the results of the credit score determination and information about ways to develop a credit score.

Still referring to FIG. 4, box 207 shows that a customer having a credit score may receive the credit score along with an explanation of the basis for the score along with advice about how to modify or dispute the credit score. Furthermore, and as shown in boxes 208 and 209, the customer may print off or save the results of the credit score determination and information about ways to improve or dispute the reported credit score.

Next, the financial institution may determine whether the customer can be guaranteed approval for a financial product, as shown in box 212. To make this determination, the financial institution may compile and analyze customer data obtained from the customer application, credit bureaus, prior or existing relationships between the customer and the financial institution or from other sources, including third-party source. Moreover, the financial institution may determine whether a customer can be guaranteed a financial product according to financial institution policies, common industry standards, federal guidelines or requirements, or according to any other guideline, standard, or policy that may be relevant to make such a determination. If the customer is not guaranteed approval for a product, the financial institution may determine whether the customer can be guaranteed terms or rate for a financial product, as shown in box 213. If the customer is not pre-qualified for any terms or line, as shown at box 215, the customer may be presented with recommendations for financial products that they could apply for. On the other hand, if the financial institution determines that the customer is not guaranteed approval for any financial products (as shown in box 212), but is guaranteed approval for terms or line (as shown in box 213), the customer may be presented with all pre-qualified offers along with the guaranteed terms or line, as shown at box 216.

At box 219, the customer may decide to apply for the presented financial products. Because the financial institution has not yet received a request for a financial product and has not guaranteed approval of the application at this point, the financial institution may process the application at box 221. If approved, the customer may be enrolled in the financial product at box 223. If declined, the financial institution may notify the customer at box 224 in an appropriate manner. In an exemplary embodiment, the financial institution may provide the customer with its rationale in declining the customer for the applied-for financial product.

If the financial institution determines that the customer is guaranteed approval for a financial product, the financial institution may then evaluate whether the customer is guaranteed approval for particular terms or a line, as shown in box 214. If the customer is not guaranteed any terms or a line at this point, the customer may be presented with all guaranteed approval offers along with a range of terms, as shown in box 216a. However, if the financial institution determines that the customer is guaranteed approval for any terms or lines at box 214, the customer may be presented with all, or some, of the guaranteed approval options, as shown in box 217. In exemplary embodiments, the financial institution may provide the guaranteed terms to the customer or it may opt to withhold this information from the customer.

At box 218, the customer may decide whether to apply for the guaranteed financial products. Since the products have already been guaranteed, it is still necessary for the financial institution to formally approve the customer. This application for the guaranteed product enables the customer to be provided with the financial product.

It should be appreciated that each of the steps described above with reference to FIG. 4 may be accomplished electronically, either within or external to, a financial institution network. In various exemplary embodiments, processors, databases, and other network elements may be utilized to affect each of the steps described above with regard to FIG. 4. Moreover, the communication devices described above with regard to FIG. 1 may also be utilized to affect the foregoing steps describe above with regard to FIG. 4.

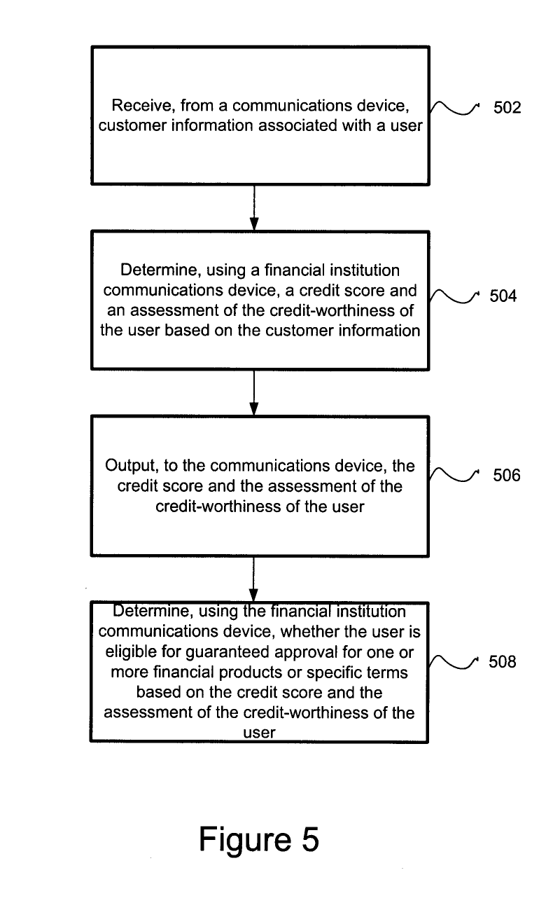

FIG. 5 depicts another flowchart for a method of pre-qualifying and guaranteeing a customer for a financial product according to an exemplary embodiment. This exemplary method is provided by way of example, as there are a variety of ways to carry out methods disclosed herein. The method shown in FIG. 5 may be executed or otherwise performed by one or a combination of various systems. The method is described below as carried out by the financial institution communication device 102 shown in FIG. 1 by way of example, and various elements of the financial institution communication device 102 are referenced in explaining the example method. Each block shown in FIG. 5 represents one or more processes, methods, or subroutines carried out in the exemplary method. Referring to FIG. 5, the exemplary method may begin at box 502.

In box 502, the method may include receiving customer information associated with a user from a communications device. In one embodiment, customer information may be received from a customer communications device 101, a third-party communication device 103, or a financial institution database (e.g., associated with a financial institution communication device 102, associated with a financial institution branch communication device 104). The method may continue to box 504.

In box 504, the method may include determining, using a financial institution communications device, a credit score and an assessment of the credit-worthiness of the user based on the customer information. In one embodiment, one or more credit scores associated with a customer may be accessed by communicating with one or more third-party systems. In another embodiment, one or more credit scores associated with a customer may be accessed by communicating with an internal credit score system that is associated with the financial institution communication device 102 or the financial institution branch communication device 104. The method may continue to box 506.

In box 506, the method may include outputting, to the communications device, the credit score and the assessment of the credit-worthiness of the user. In one embodiment, the credit score and the assessment may be outputted prior to determining whether a customer is eligible for guaranteed approval for one or more financial products or one or more guaranteed terms associated with a financial product. The method may continue to box 508.

In box 508, the method may include determining, using the financial institution communications device, whether the user is eligible for guaranteed approval for one or more financial products based on the credit score and the assessment of the credit-worthiness of the user. The method may then end.

The description above describes user devices, an analysis system, a communication network having network elements that are coupled to each other via one or more links (e.g., physical or logical), various networks within a domain of the communication network, and other elements for coupling customer to the communication network, some of which are explicitly depicted, other of which are not. As used herein, the term “module” may be understood to refer to executable software, firmware, hardware, or various combination thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein maybe tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A computer-implemented method for providing a guaranteed financial product to a customer comprising:
receiving, from a communications device, customer information associated with a user;
determining, using a financial institution communications device, a credit score and an assessment of the credit-worthiness of the user based on the customer information;
outputting, to the communications device, the credit score and the assessment of the credit-worthiness of the user; and
determining, using the financial institution communications device, whether the user is eligible for guaranteed approval for one or more financial products based on the credit score and the assessment of the credit-worthiness of the user.

2. The computer-implemented method of claim 1, wherein the customer information is received from the user.

3. The computer-implemented method of claim 1, wherein the customer information is received from a third-party.

4. The computer-implemented method of claim 1, wherein the customer information is received from a financial institution database.

5. The computer-implemented method of claim 1, wherein at least one of the credit score and the assessment of the credit-worthiness of the user is outputted prior to determining whether the user is eligible for guaranteed approval for one or more financial products.

6. The computer-implemented method of claim 1, further comprising offering the user one or more financial products for which the user is eligible for guaranteed approval.

7. The computer-implemented method of claim 1, further comprising:
determining whether the user is eligible for one or more guaranteed terms associated with at least one financial product based on the credit score and the assessment of the credit-worthiness of the user; and
offering the user the at least one financial product for which the user is eligible for one or more guaranteed terms.

8. The computer-implemented method of claim 1, further comprising:
receiving enrollment information associated with an offered financial product from the user; and
enrolling the user in the offered financial product.

9. The computer-implemented method of claim 1, wherein the assessment of the credit-worthiness of the user is associated with advice for improving the credit score.

10. The computer-implemented method of claim 1, wherein the customer information is received via a specific application type.

11. The computer-implemented method of claim 10, wherein the specific application type is selected by the user.

12. The computer-implemented method of claim 10, wherein the specific application type is selected by a financial institution.

13. The computer-implemented method of claim 10, wherein the specific application type is selected based on at least one of user geographical location, demographic information, and random sampling.

14. A system for providing a guaranteed financial product to a customer comprising:
a programmed processor configured to receive, from a communications device, customer information associated with a user;
a programmed processor configured to determine a credit score and an assessment of the credit-worthiness of the user based on the customer information;
a programmed processor configured to output the credit score and the assessment of the credit-worthiness of the user to the communications device; and
a programmed processor configured to determine whether the user is eligible for guaranteed approval for one or more financial products based on the credit score and the assessment of the credit-worthiness of the user.

15. The system of claim 14, wherein the customer information is received from the user.

16. The system of claim 14, wherein the customer information is received from a third-party.

17. The system of claim 14, wherein the customer information is received from a financial institution database.

18. The system of claim 14, wherein at least one of the credit score and the assessment of the credit-worthiness of the user is outputted prior to determining whether the user is eligible for guaranteed approval for one or more financial products.

19. The system of claim 14, further comprising a programmed processor configured to offer the user one or more financial products for which the user is eligible for guaranteed approval.

20. The system of claim 14, further comprising:
a programmed processor configured to determine whether the user is eligible for one or more guaranteed terms associated with at least one financial product based on the credit score and the assessment of the credit-worthiness of the user; and
a programmed processor configured to offer the user the at least one financial product for which the user is eligible for one or more guaranteed terms.
